(19) United States
(12) Patent Application Publication
(10) Pub. No.: US 2014/0236564 A1
(43) Pub. Date: Aug. 21, 2014

(54) COVERAGE MODEL AND MEASUREMENTS FOR PARTIAL INSTRUMENTATION

(71) Applicant: INTERNATIONAL BUSINESS MACHINES CORPORATION, Armonk, NY (US)

(72) Inventors: Marina Biberstein, Haifa (IL); Eitan D. Farchi, Pardes Hana (IL); Andre Heilper, Haifa (IL); Sharon Keidar-Barner, Megiddo (IL); Aviad Zlotnick, Mitzpeh Netofah (IL)

(73) Assignee: International Business Machines Corporation, Armonk, NY (US)

(21) Appl. No.: 13/771,096

(22) Filed: Feb. 20, 2013

(51) Int. Cl. G06F 11/34

(52) U.S. Cl. CPC G06F 11/3447
USPC 703/21

(57) ABSTRACT

A computer implemented method, an apparatus and a computer program product for instrumentation coverage. The method comprising: determining an instrumentation coverage model of a system having components, the instrumentation coverage model defining instrumentation tasks of the system, wherein each instrumentation task defines a subset of the components to be monitored; and monitoring the system by a computer, wherein during said monitoring applying a plurality of partial instrumentation tasks defining strict subsets of the components to be monitored.

### TECHNICAL FIELD

The present disclosure relates to instrumentation of computerized systems in general, and to partial instrumentation, in particular.

### BACKGROUND

Instrumentation is an ability to augment a computerized system to collect information regarding its operation. Instrumentation may be useful for measuring performance of the system, diagnosing errors, writing trace information (e.g. log), changing execution flow for detecting concurrency bugs, measuring code coverage, or the like.

In some cases, instrumentation may be implemented by an addition of instrumentation code to a computer program, computerized device, component, or the like (hereinafter referred to generally as system). The instrumentation code may be operative to track performance metrics, output logging information, or the like. The instrumentation code may be introduced at source code level, at binary level, or the like. Additionally or alternatively, the system may be pre-equipped with instrumentation code that may be enabled or disabled using a management tool. One example of such scenario is a system configured to log events at different verbosity levels, such as no logging, logging of errors only, logging of errors and warnings, and logging of all messages including errors, warnings, and debug information.

Instrumentation may introduce overhead to execution time, and may output large data volumes which need to be stored and reviewed (manually or automatically).

For example, when monitoring multi-threaded programs, events can be collected in one logger using light synchronization mechanisms to allocate entries on the logger by the threads. Monitoring all threads/events together may yield contention in the monitoring code which causes significant overhead in execution time, to the extent that the collected information does not reflect the monitored software's activity in real conditions, or even to the extent that the monitored software ceases to function. Adding overhead in execution time may completely change the functionality or influence the monitored application's performance, creating new bottlenecks or making other bottlenecks less visible.

In addition, the volume of data collected may become unmanageable over time. However, large portion of this data may not be relevant or may be redundant with respect to the monitoring goals.

In another example, delays may be introduced using instrumentation for the purpose of detecting concurrency bugs due to race conditions. However, if the delays are introduced at every possible point (e.g., after every instruction), the performance of the software may deteriorate. Detecting concurrency bugs may be a lengthy process and in some cases the software under test may fail to work.

### BRIEF SUMMARY

One exemplary embodiment of the disclosed subject matter is a computer-implemented method comprising: determining an instrumentation coverage model of a system having components, the instrumentation coverage model defining instrumentation tasks of the system, wherein each instrumentation task defines a subset of the components to be monitored; and monitoring the system by a computer, wherein during said monitoring applying a plurality of partial instrumentation tasks defining strict subsets of the components to be monitored.

Another exemplary embodiment of the disclosed subject matter is a computerized apparatus having a processor coupled with a memory unit, the processor being adapted to perform the steps of: determining an instrumentation coverage model of a system having components, the instrumentation coverage model defining instrumentation tasks of the system, wherein each instrumentation task defines a subset of the components to be monitored; and monitoring the system, wherein during said monitoring applying a plurality of partial instrumentation tasks defining strict subsets of the components to be monitored.

Yet another exemplary embodiment of the disclosed subject matter is a computer program product comprising a non-transitory computer readable medium retaining program instructions, which instructions when read by a processor, cause the processor to perform the steps of: determining an instrumentation coverage model of a system having components, the instrumentation coverage model defining instrumentation tasks of the system, wherein each instrumentation task defines a subset of the components to be monitored; and monitoring the system, wherein during said monitoring applying a plurality of partial instrumentation tasks defining strict subsets of the components to be monitored.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a flowchart diagram of steps in a method, in accordance with some exemplary embodiments of the disclosed subject matter;

FIG. 1B shows a flowchart diagram of steps in a method, in accordance with some exemplary embodiments of the disclosed subject matter; and

FIG. 2 shows a block diagram of components of an apparatus, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure, the terms “instrumentation”, “logging” and “monitoring” may be used interchangeably to generally refer to collection of data during execution of a system regarding the operation thereof.

One technical problem dealt with the disclosed subject matter is providing selective instrumentation to avoid expensive execution time and overhead and large volumes of redundant data. The selective instrumentation may provide sufficient information for the purpose for which the instrumentation is performed.

One technical solution provided by the disclosed subject matter is to define an instrumentation coverage model describing potential combination of instrumented portions of the system and provide alternative instrumentations of the system which provide sufficient coverage of the coverage model.

As an example, the system may be composed of separate components (e.g., threads, modules of an Operating System, processes, or the like). The instrumentation coverage model may define tuples indicating which components are instrumented. For example, the instrumentation coverage model may define n components denoted as C₁ . . . Cₙ and provide potential combinations of instrumentation of the system. A tuple, also referred to as instrumentation task, may define which subset of the components is instrumented. The tuple may comprise n values indicating for each component whether or not it is instrumented. For example the set (T,F,T,F) may indicate that only C₁ and C₃ are instrumented and the rest of the components are not instrumented.

Additionally or alternatively, when different forms of instrumentation are possible, such as indicating different verbosity levels, the tuple may indicate verbosity level of each component.

Additionally or alternatively, in a system where several components are considered symmetric, a combination may be denoted by a tuple of m values, where m is the number of different types of components (i.e., there are T₁ . . . Tₘ types of components). A value in the set indicates how many components of a specific type are instrumented. As an example, the set (0, 2, 1, 5) indicates 2 components of type T₂, 1 component of type T₃ and 5 components of type T₄ are instrumented and the rest of the components (All components of type T₁ and other components of types T₂, T₃, or T₄) are not instrumented.

In some exemplary embodiments, one instrumentation task may be a subset of another instrumentation task of the instrumentation coverage model. As an example, consider the instrumentation task indicating every component of the system is instrumented (“full instrumentation task”). Each instrumentation task that corresponds to a partial instrumentation task is included in the full instrumentation task, by definition. As another example, the instrumentation task (T,F,T,F) includes a first instrumentation task (T,F,T,F) and a second instrumentation task (F,F,T,F). In some exemplary embodiments, after performing the instrumentation task (T,F,T,F), performing the first or second instrumentation tasks may be redundant. In some exemplary embodiments, each instrumentation task may be considered separate as a partial instrumentation may provide different information than full instrumentation in view of the overhead of performing full instrumentation.

In some exemplary embodiments, the instrumentation coverage model may be defined so as to exclude certain instrumentation tasks. As an example, instrumentation coverage tasks which require instrumentation of more than K components may be excluded.

As another example, instrumentation coverage tasks in which two components that cannot operate at the same time are instrumented may be excluded. As another example, instrumentation coverage tasks in which two components that can co-exist but do not use shared resources may be excluded, such as threads that use the same semaphore, use a shared memory, or can otherwise affect the functionality of one another.

The instrumentation coverage model may be useful to allow using several partial instrumentations to collect data instead of instrumenting the entire system at once. In some exemplary embodiments, the instrumentation may be performed to a limited number of components, such as no more than K components. In some exemplary embodiments, an instrumentation task in the coverage model corresponding to the partial instrumentation performed may be deemed as covered and an uncovered instrumentation task may be performed thereafter to allow for collection of information no included in the partial instrumentation performed.

Another technical solution is to determine an instrumentation plan indicating a set of instrumentations to be performed in order to achieve sufficient data. In some exemplary embodiments, the instrumentation plan may be determined using Combinatorial Test Design (CTD) methods, such as depicted in M. Grindal, J. Offutt, and S. F. Andler. Combination Testing Strategies: A Survey. Software Testing, Verification, and Reliability, 15:167-199, 2005, which is hereby incorporated by reference in its entirety. An interaction level between components may be determined, such as every pair of components is instrumented, every triplet is instrumented, or the like. In some exemplary embodiments, the interaction may be relevant only to components which can affect the functionality of one another.

In some exemplary embodiments, combinatorial coverage methods may be utilized to maximize the probability to observe all the data needed for the monitoring goal while obtaining low redundancy. The decisions which data to collect is done with respect to predefined monitoring goals.

Additionally or alternatively, a dynamic test planning algorithm may be provided in which after the system is instrumented, instrumentation tasks that are covered by the instrumentation are marked as “covered” and the system may be operated using a different instrumentation, based on an instrumentation task which was not yet covered.

Another technical solution is to provide different selective instrumentation of the system at the same operation. In some exemplary embodiments, the system may be operated and the instrumentation may be modified dynamically so that in a first portion of operation a first instrumentation task is performed and in a second portion of the operation a second instrumentation task is performed.

Yet another technical solution is to modify instrumentation on-the-fly, such as by dynamically replacing libraries used by the system, by utilizing verbosity instructions to the system, or the like. In some exemplary embodiments, the instrumented portions may be modified at different execution intervals. Additionally or alternatively, the instrumentation may be pre-fixed before operation of the system and may remain unmodified throughout its operation.

One technical effect of utilizing the disclosed subject matter is to allow for balancing between overhead and data volume without losing ability to receive information regarding the entire system. Though some information is lost due to partial instrumentation, there may be a relatively high probability that the data collected is sufficient for the desired analysis.

Another technical effect is providing a coverage metric measuring sufficient coverage of the partial instrumentations performed. The coverage metric may indicate whether or not additional instrumentation should be performed.

It will be noted that the disclosed subject matter is orthogonal to which purpose the instrumentation is used for, and may be used for a variety of purposes such as but not limited to code coverage, performance analysis, execution replay, or the like.

Yet another technical effect is the surprising effect of using partial instrumentation without forfeiting useful information for the desired analysis, as defined based on the coverage model.

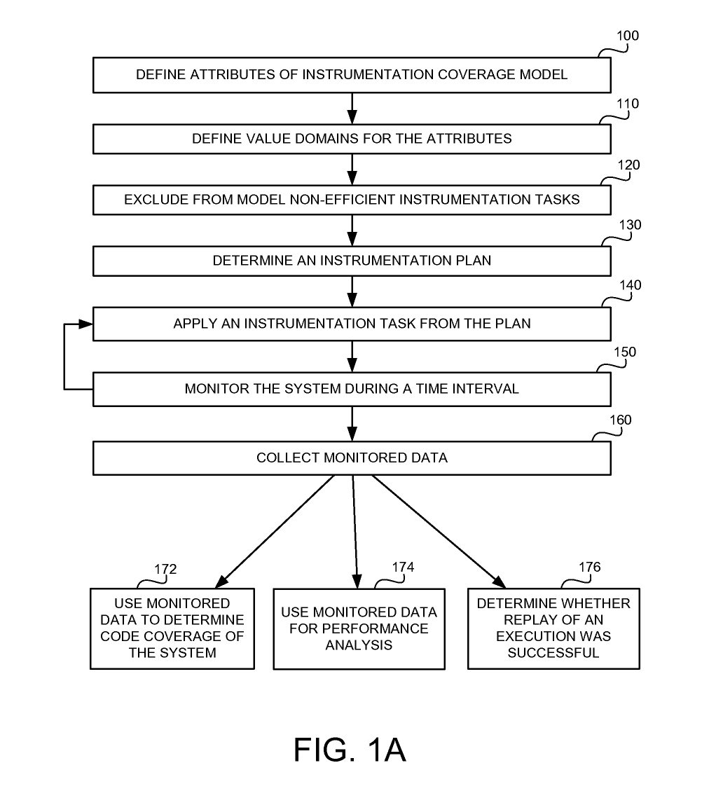

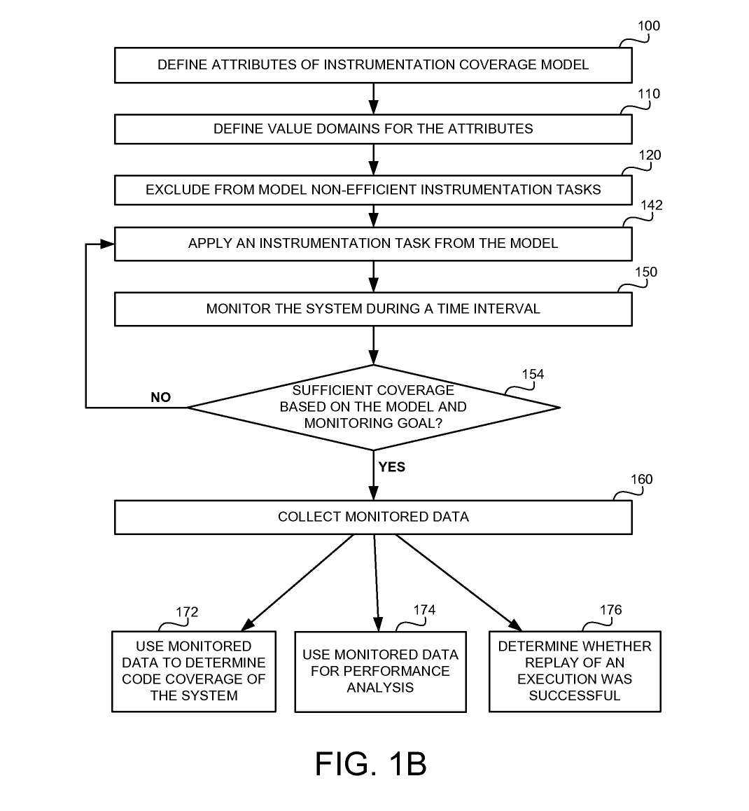

Referring now to FIG. 1A showing a flowchart diagram of steps in a method, in accordance with some exemplary embodiments of the disclosed subject matter.

In Steps 100-120, an instrumentation coverage model may be defined.

In Step 100, attributes of the instrumentation coverage model may be defined. Each component of the system may be associated with a unique attribute indicating whether and in what way the component is instrumented. In some exemplary embodiments, similar or identical components may be grouped together and referred to using a single attribute indicating a portion of the set of similar components, hereinafter referred to as components of the same type, that are instrumented, thereby allowing the instrumentation coverage model to take into consideration components having symmetrical properties. In Step 110, a value domain may be defined for each attribute. The value may be, for example, True indicating component is instrumented and False indicating component is not instrumented. The value may indicate manner of instrumentation, such as verbosity level. In some exemplary embodiments, the value may indicate a number of components of the same type that are instrumented and in what manner they are instrumented. In Step 120, constraints may be introduced to the instrumentation model to exclude certain instrumentation tasks, such as instrumentation tasks that are unfeasible (e.g., two components that cannot be instrumented at the same time), non-efficient (e.g., instrumenting components that do not interact with one another via a shared resource, instrumenting a number of components higher than a predetermined threshold, instrumenting a number of components lower than a predetermined threshold, or the like), or the like.

In Step 130, a instrumentation plan may be determined based on the instrumentation coverage model. The instrumentation plan may be determined based on selection of instrumentation tasks to be performed that are configured to reach a monitoring goal, such as a desired interaction level between components of the system. In some exemplary embodiments, the instrumentation plan may be determined by performing CTD on the instrumentation coverage model. In some exemplary embodiments, the instrumentation plan may be determined automatically, manually or combination thereof.

In Steps 140-150, an iterative process of instrumenting the system according to an instrumentation task and monitoring the system may be performed. In Step 140, an instrumentation task not previously performed may be applied on the system. The instrumentation task may be applied while the system is operating (e.g., dynamically) or prior to operating the system (e.g., statically). In Step 150, the system may be monitored during a time interval, such as based on a timeframe defined by a user, by a preference file, or the like.

In some exemplary embodiments, in case the instrumentation is applied dynamically, the instrumentation task may be selected from the plan based on the components that are operating in the system. As an example, a thread in a software system may be created during execution of the system and may terminate prior to the termination of the software. In such a system, and in case the thread is not operational when the instrumentation task is to be applied, instrumentation tasks that do not require monitoring the inactive thread may be preferred over an instrumentation task that instruments the inactive thread.

In Step 160, the monitored data collected from all instrumentation time intervals may be collected and used for a target purpose.

In some exemplary embodiments, the instrumentation may be performed in order to determine code coverage (172). Code coverage may be determined based on a code coverage model and with respect to an execution of the system on a test suite. It will be noted that the code coverage model is different than the instrumentation coverage model. In fact, using an instrumentation coverage model may have an adverse effect of intentionally failing to track execution of certain code portions of the system.

In some exemplary embodiments, the instrumentation may be performed for performance analysis purposes (174). The monitored data may include information regarding resource utilization by the system and other metrics useful for analyzing performance of the system. The monitored data may be inspected to provide insights into bottlenecks or the system, or other performance issues.

In some exemplary embodiments, the instrumentation may be aimed at modifying or directing operation of the system, such as enforcing specific scheduling of concurrent entities in order to replay an execution (176). The monitored data may be used to indicate whether or not the replay attempt was successful.

Additionally or alternatively, the instrumentation may be aimed at collecting data useful for debugging. As an example, data may be collected in order to enable analysis of a bug, such as a deadlock.

Instrumentation may be performed for other uses as well and the disclosed subject matter is not limited by the specific usage of the monitored data or the goal of the instrumentation.

Referring now to FIG. 1B showing a flowchart diagram of steps in a method, in accordance with some exemplary embodiments of the disclosed subject matter.

In Step 110, an instrumentation coverage model may be obtained, such as for example from a user, from an electronic source, or the like. The instrumentation coverage model may be defined by the user by defining attributes and their corresponding domains. In some exemplary embodiments, the model may be defined using restrictions to exclude certain combinations of values of different attributes. In some exemplary embodiments, a monitoring goal over the instrumentation coverage model may be defined, such as cover every n-wise combinations of components that have the potential of affecting one another. In some exemplary embodiments, Step 110 may be implemented by Steps 100-120 of FIG. 1A.

In Step 142, an instrumentation task may be selected from the instrumentation coverage model and may be applied on the system. In some exemplary embodiments, the instrumentation task may be applied on the system while operating and be selected based on active and inactive components of the system. Additionally or alternatively, the instrumentation task may be applied prior to operating the system. The instrumentation task may be selected from the instrumentation tasks of the instrumentation coverage model which were not yet covered. The selected instrumentation task may be deemed as covered after the system is monitored (150).

In Step 154, it may be determined whether or not sufficient coverage of the instrumentation coverage model was achieved with respect to a monitoring goal. As an example only, it may be determined whether or not every n-wise combinations of components that have the potential of affecting one another were monitored at the same time.

Steps 142-154 may be performed repeatedly, each time selecting a different instrumentation task, until sufficient coverage is reached. Once sufficient coverage is achieved, Step 160 may be performed to collect the monitored data to be used for any purpose, such as but not limited to code coverage (172), performance analysis (174) and scheduling intervention (176).

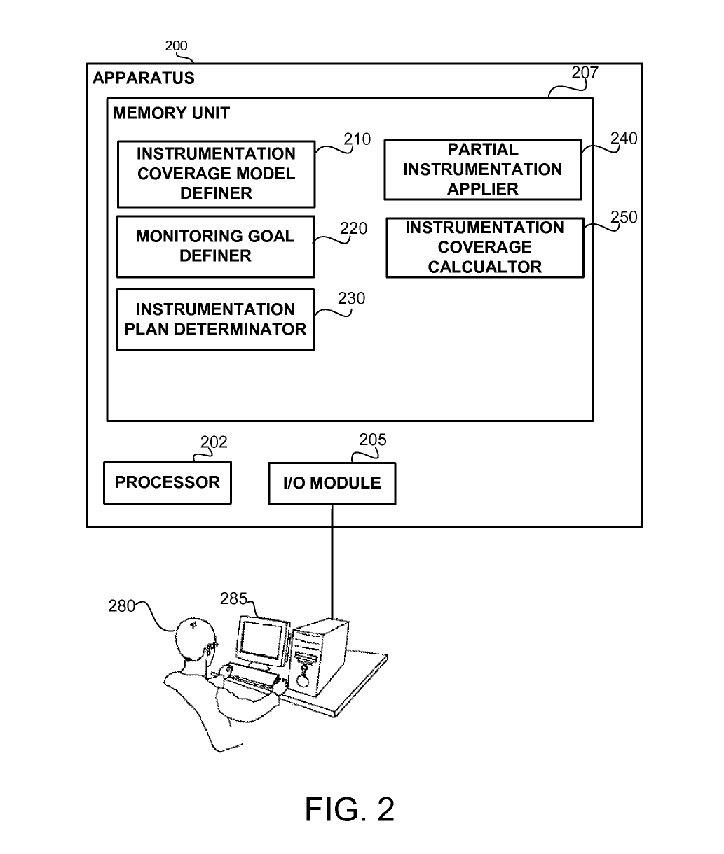

Referring now to FIG. 2 showing a block diagram of components of an apparatus, in accordance with some exemplary embodiments of the disclosed subject matter. An apparatus 200 may be a computerized apparatus adapted to perform methods such as depicted in FIGS. 1A, 1B.

In some exemplary embodiments, Apparatus 200 may comprise a Processor 202. Processor 202 may be a Central Processing Unit (CPU), a microprocessor, an electronic circuit, an Integrated Circuit (IC) or the like. Alternatively, Apparatus 200 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). The processor 202 may be utilized to perform computations required by Apparatus 200 or any of it subcomponents.

In some exemplary embodiments of the disclosed subject matter, Apparatus 200 may comprise an Input/Output (I/O) Module 205 such as a terminal, a display, a keyboard, an input device or the like to interact with the system, to invoke the system and to receive results. It will however be appreciated that the system can operate without human operation.

In some exemplary embodiments, the I/O Module 205 may be utilized to provide an interface to a User 280 which may utilize a Man-Machine Interface (MMI) 285 to interact with Apparatus 200, such as by defining the instrumentation coverage model, defining a monitoring goal, reviewing results, logs, monitored data, providing commands, rules, preferences, formulas or the like, or interacting in any similar manner.

In some exemplary embodiments, Apparatus 200 may comprise a Memory Unit 207. Memory Unit 207 may be persistent or volatile. For example, Memory Unit 207 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 207 may retain program code operative to cause Processor 202 to perform acts associated with any of the steps shown in FIG. 1A, 1B above.

The components detailed below may be implemented as one or more sets of interrelated computer instructions, executed for example by Processor 202 or by another processor. The components may be arranged as one or more executable files, dynamic libraries, static libraries, methods, functions, services, or the like, programmed in any programming language and under any computing environment.

An Instrumentation Coverage Model Definer 210 may be configured to define an instrumentation coverage model, such as based on input from User 280 or from a different source.

A Monitoring Goal Definer 220 may be configured to define a monitoring goal indicative of a desired coverage of the instrumentation tasks defined by the instrumentation coverage model. The monitoring goal may be obtained from User 280 or from a different source.

An Instrumentation Plan Determinator 230 may be configured to determine an instrumentation plan comprising a set of partial instrumentation tasks that, if used, would achieve the monitoring goal over the instrumentation coverage model. The instrumentation plan may be determined automatically such as based on a greedy algorithm, based on a combinatorial algorithm selecting a subset of the instrumentation tasks that would provide sufficient interaction required by the monitoring goal at a minimal or close to minimal number of instrumentation tasks, or the like.

A Partial Instrumentation Applier 240 may be configured to apply an instrumentation task to a system. The instrumentation task may be a partial instrumentation task in which not all components of the system are instrumented. In some exemplary embodiments, the instrumentation task may be applied prior to activating the system (e.g., in a static manner), while the system is operating (e.g., in a dynamic manner), or the like.

An Instrumentation Coverage Calculator 250 may be configured to compute an instrumentation coverage metric indicating whether or not the monitoring goal is achieved with respect to the instrumentation coverage model. In some exemplary embodiments, the instrumentation coverage metric may take into consideration that some instrumentation tasks may not be applicable, such as because the components to be monitored are not active concurrently.

### An Embodiment

The below is an exemplary embodiment. The disclosed subject matter is not limited to the particulars of the embodiments.

In a system of multithreaded software, partial instrumentation may be performed limiting the number of instrumented threads to no more than K at the same time. For simplicity, an instrumented component is referred to as having an online logger collecting events associated with the instrumented component.

A monitoring goal is identified, such as every two concurrent threads have to be monitored together for at least a predetermined timeframe. The execution of the system may be split into time intervals based on the predetermined timeframe. At each interval the subset of threads being monitored may be changed, so that eventually all monitoring goals are covered. It will be noted that unmonitored threads keep running.

Given any clustering method for threads each cluster may be considered as a different class of threads. Note that in cases there is a thread pool a specific thread may be in o different cluster if it is fetched more than once from the pool. In this case its class may change.

The instrumentation coverage model may be defined using attributes corresponding to each class of threads. Each such attribute may be assigned any non-negative integer value indicating a number of monitored threads of the class. The attributes may be defined as follows: ThreadClass₁, . . . ThreadClassₙ: ( ) . . . m. If ThreadClassᵢ=j then j threads from class i are monitored (i.e., instrumented). If j is zero than no thread from this class is monitored.

The instrumentation model may define instrumentation tasks based on the Cartesian Product of the attributes. In some exemplary embodiments, constraints on the instrumentation tasks may be defined. The constraints may exclude certain instrumentation tasks. In some exemplary embodiments, one constraint may be ΣThreadClassᵢ≦K ensuring that only K loggers are used at the same time. Another constraint may be that ThreadClassᵢ>0 and ThreadClassⱼ>0 if the two class of threads can co-exist. Additionally or alternatively, ThreadClassᵢ>0 and ThreadClassⱼ>0 if the two class of threads use a shared resource or otherwise may affect the functionality of one another.

A monitoring goal may be to cover every n-wise combination of components, also referred to as interaction level. As an example, every pair, triplet, or the like, of threads may be instrumented together. In some exemplary embodiments, an interaction level of three may indicate that each combination of three threads is instrumented in the same time, such as but not limited to three threads of the same type, three threads of different types, or the like.

In some exemplary embodiments, every instrumentation task in which at least one attribute value is 0 may be defined as “don't care”.

In a static environments, where threads may be known in advance, a planning algorithm, such as CTD, can produce a set of instrumentation tasks from the model indicating a sufficient set of instrumentations to achieve sufficient coverage of the system.

In a dynamic environment, the model may be used to create a list of required value tuples, and at every time interval the assignment of loggers to existing threads that cover the most uncovered tuple is chosen. In some exemplary embodiments, the list of required value tuples may be recalculated at every time interval if a previously unknown thread is detected or a monitored thread dies or returned to the threads pool.

In some exemplary embodiments, the interaction between the threads may be defined based on the monitoring goal in order to decide which data to collect. For example, if the monitoring goal is to identify Hot Mutexes the following classification may be used: each thread cluster may be categorized by the following characteristics: (1) The stack trace related to the thread's creation. (or fetched from a pool of threads); and (2) The subset of mutexes the thread uses.

It will be noted that for the static algorithm the data for clustering can be collected in static analysis or in a base-line run.

In some exemplary embodiments, the volume of the data collected may depended on the characteristic of the instrumentation coverage model, such as but not limited to clustering of threads, constraints and requirements.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method comprising:
determining an instrumentation coverage model of a system having components, the instrumentation coverage model defining instrumentation tasks of the system, wherein each instrumentation task defines a subset of the components to be monitored; and
monitoring the system by a computer, wherein during said monitoring applying a plurality of partial instrumentation tasks defining strict subsets of the components to be monitored.

2. The computer-implemented method of claim 1, wherein said monitoring comprises operating the system for a plurality of time intervals, wherein during each time interval said monitoring the system is based on a different instrumentation task.

3. The computer-implemented method of claim 1 further comprises determining a monitoring goal over the instrumentation coverage model, and wherein said monitoring is performed until the monitoring goal is reached.

4. The computer-implemented method of claim 1 further comprising collecting information during said monitoring.

5. The computer-implemented method of claim 4, wherein the information is useful for performance analysis of the system.

6. The computer-implemented method of claim 4, wherein based on the information and based on a code coverage model, determining code coverage of the system with respect to a test suite.

7. The computer-implemented method of claim 4 further comprising debugging the system using the information.

8. The computer-implemented method of claim 1 further comprises determining based on the instrumentation coverage model and based on a target interaction level between the components, an instrumentation plan, the instrumentation plan comprising the plurality of partial instrumentation tasks.

9. The computer-implemented method of claim 1, wherein in response to the system being monitored based on a partial instrumentation task, indicating two or more instrumentation tasks that are subsumed by the partial instrumentation task as covered.

10. The computer-implemented method of claim 1, wherein the instrumentation coverage model defining a threshold number of components to be monitored at the same time.

11. The computer-implemented method of claim 1, wherein the instrumentation coverage model excluding instrumentation tasks in which components that do not use a shared resource are monitored at the same time.

12. A computerized apparatus having a processor coupled with a memory unit, the processor being adapted to perform the steps of:
determining an instrumentation coverage model of a system having components, the instrumentation coverage model defining instrumentation tasks of the system, wherein each instrumentation task defines a subset of the components to be monitored; and
monitoring the system, wherein during said monitoring applying a plurality of partial instrumentation tasks defining strict subsets of the components to be monitored.

13. The computerized apparatus of claim 12, wherein said monitoring comprises operating the system for a plurality of time intervals, wherein during each time interval, the system is monitored based on a different instrumentation task.

14. The computerized apparatus of claim 12, wherein the processor is further adapted to determine a monitoring goal over the instrumentation coverage model, and wherein said monitoring is performed until the monitoring goal is reached.

15. The computerized apparatus of claim 12, wherein the processor is further adapted to collect information during said monitoring.

16. The computerized apparatus of claim 12, wherein the processor is further adapted to determine, based on the instrumentation coverage model and based on a target interaction level between the components, an instrumentation plan, the instrumentation plan comprising the plurality of partial instrumentation tasks.

17. The computerized apparatus of claim 12, wherein the processor is further adapted to indicate two or more instrumentation tasks that are subsumed by a partial instrumentation task as covered, in response to the system being monitored based on the partial instrumentation task.

18. The computerized apparatus of claim 12, wherein the instrumentation coverage model defining a threshold number of components to be monitored at the same time.

19. The computerized apparatus of claim 12, wherein the instrumentation coverage model excluding instrumentation tasks in which components that do not use a shared resource are monitored at the same time.

20. A computer program product comprising a non-transitory computer readable medium retaining program instructions, which instructions when read by a processor, cause the processor to perform the steps of:
determining an instrumentation coverage model of a system having components, the instrumentation coverage model defining instrumentation tasks of the system, wherein each instrumentation task defines a subset of the components to be monitored; and
monitoring the system, wherein during said monitoring applying a plurality of partial instrumentation tasks defining strict subsets of the components to be monitored.
